(19) United States
(12) Patent Application Publication
(10) Pub. No.: US 2009/0162650 A1
(43) Pub. Date: Jun. 25, 2009

(54) Adhesive film composition for semiconductor assembly, adhesive film, dicing die bonding film, device package, and associated methods

(76) Inventors: Yong Woo Hong, Uiwang-si (KR); Wan Jung Kim, Uiwang -si (KR); Su Mi Im, Uiwang-si (KR); Ah Ram Pyun, Uiwang-si (KR); Chul Jeong, Uiwang-si (KR); Sang Jin Kim, Uiwang-si (KR); Chang Beom Chung, Uiwang-si (KR)

Correspondence Address: LEE & MORSE, P.C., 3141 FAIRVIEW PARK DRIVE, SUITE 500, FALLS CHURCH, VA, 22042, US

(21) Appl. No.: 12/314,973

(22) Filed: Dec. 19, 2008

(30) Foreign Application Priority Data
Dec. 20, 2007 (KR) 10-2007-0134390

(51) Int. Cl. B32B 7/12; B32B 7/10; B32B 27/18; B32B 15/092; C08L 71/10; C08K 11/00; C08K 5/50

(52) U.S. Cl. 428/354; 156/329; 428/414; 428/416; 525/393; 524/540; 524/154

(57) ABSTRACT

An adhesive film composition for semiconductor assembly includes an elastomer resin, an epoxy resin, a phenolic curing resin, and a silsesquioxane oligomer. The silsesquioxane oligomer may be present in an amount of about 0.01 to about 3 wt. %, based on the total solids content of the composition.

### BACKGROUND

1. Technical Field

Embodiments relate to an adhesive film composition for semiconductor assembly, an adhesive film, a dicing die bonding film, a device package, and associated methods.

2. Description of the Related Art

Copper, Alloy 42, and printed circuit boards (PCBs) have been used to support semiconductor devices, and silver (Ag) pastes have been employed to bond semiconductor devices to support members. With the trend toward miniaturization and increased capacity of semiconductor devices, support members used for the semiconductor devices are required to be smaller in size and have features with a finer pitch.

There is a growing tendency to use adhesive films for bonding instead of silver pastes. An adhesive film for use in semiconductor assembly may be used together with a dicing film, which is employed to fix a semiconductor wafer during dicing. Dicing, which is a process in which the semiconductor wafer is cut into individual chips, may be followed by expansion, die bonding, wire bonding, and curing. Die bonding is a process in which the die is attached to a next-level substrate, e.g., a PCB, lead frame, etc. Wire bonding is a process in which metal wires are connected to the chips and connection terminals through, e.g., gold or aluminum lines. Curing is a process in which a portion of the adhesive member is cured, e.g., in an oven, to fix the die to the next-level substrate.

When a lead frame made of a metal, e.g., copper or Alloy 42, is used in the moisture absorption process defined by the Joint Electron Device Engineering Council (JEDEC), moisture may permeate the adhesive film through the interface between the adhesive film and the lead frame. The moisture permeation may cause a reduction in the adhesive strength of the adhesive film during a reflow process, leading to the occurrence of defects. Further, the reduced adhesive strength of the adhesive film may become a major cause of poor reliability during reliability tests such as a pressure cooker test (PCT) and a temperature cycling (TC) test.

### SUMMARY

Embodiments are therefore directed to an adhesive composition for die bonding in semiconductor assembly, an adhesive film including the same, a dicing die-bonding film including the same, a device package including the same, and associated methods, which substantially overcome one or more of the problems due to the limitations and disadvantages of the prior art.

It is therefore a feature of an embodiment to provide an adhesive composition including a silsesquioxane oligomer, which may provide a film having good resistance to moisture and other properties suitable for semiconductor assembly.

At least one of the above and other features and advantages may be realized by providing an adhesive film composition for semiconductor assembly, the adhesive film composition including an elastomer resin, an epoxy resin, a phenolic curing resin, and a silsesquioxane oligomer. The silsesquioxane oligomer may be present in an amount of about 0.01 to about 3 wt. %, based on the total solids content of the composition.

The silsesquioxane oligomer may be represented by Formula 1 or Formula 2:

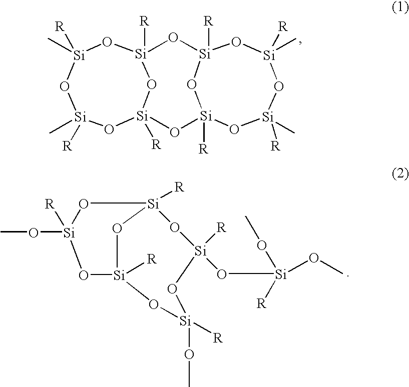

In Formulae 1 and 2, each R may independently be a hydrogen atom, an alkyl group, an alkene group, an aryl group, or an arylene group.

The elastomer resin may contain a hydroxyl, carboxyl, or epoxy group. The epoxy resin may include one or more of a bisphenol-type epoxy resin, an ortho-cresol novolac-type epoxy resin, a multifunctional epoxy resin, an amine-type epoxy resin, a heterocyclic epoxy resin, a substituted epoxy resin, or a naphthol-type epoxy resin.

The phenolic curing resin may be represented by Formula 3:

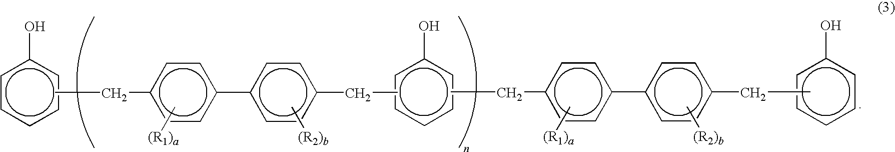

In Formula 3, R1 and R2 may each independently be a C1-C4 alkyl group or a hydrogen atom, a and b may each independently be integers from 0 to 4, and n my be an integer from 0 to 7.

The epoxy resin and the phenolic curing resin may be present in an epoxy resin epoxy equivalent:phenolic curing resin hydroxyl equivalent weight ratio of about 0.6:1 to about 1.6:1. The adhesive film composition may further include a silane coupling agent, a curing accelerator, and a filler.

The curing accelerator may include a compound represented by Formula 4:

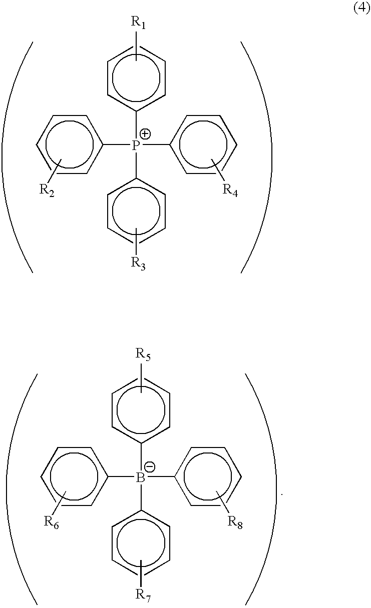

In Formula 4, R₁ through R₈ may each independently be a hydrogen atom, a halogen atom, or an alkyl group.

The filler may be an inorganic filler having a spherical or amorphous shape and a size of about 5 nm to about 10 μm.

The adhesive film composition may include about 5 to about 75 wt. % of the elastomer resin, about 3 to about 40 wt. % of the epoxy resin, about 3 to about 25 wt. % of the phenolic curing resin, about 0.01 to about 10 wt. % of the silane coupling agent, about 0.01 to about 10 wt. % of the curing accelerator, and about 3 to about 60 wt. % of the filler. The adhesive film composition may include about 5 to about 75 wt. % of the elastomer resin, about 3 to about 40 wt. % of the epoxy resin, and about 3 to about 25 wt. % of the phenolic curing resin.

At least one of the above and other features and advantages may also be realized by providing an adhesive film for semiconductor assembly, the adhesive film including an elastomer resin, an epoxy resin, a phenolic curing resin, and a silsesquioxane oligomer. The silsesquioxane oligomer may be present in an amount of about 0.01 to about 3 wt. %, based on the total solids content of the composition.

At least one of the above and other features and advantages may also be realized by providing a dicing die bonding film, including a base film, a pressure-sensitive adhesive layer on the base film, and an adhesive film on the pressure-sensitive adhesive layer, such that the pressure-sensitive adhesive layer is between the adhesive film and the base film. The adhesive film may include an elastomer resin, an epoxy resin, a phenolic curing resin, and a silsesquioxane oligomer, the silsesquioxane oligomer being present in an amount of about 0.01 to about 3 wt. %, based on the total solids content of the composition.

The pressure-sensitive adhesive layer may include an acrylic pressure-sensitive adhesive binder and a heat curing agent, the binder may have a hydroxyl value of about 15 to about 30 and an acid value of 1 or less, the binder may contain about 2 to about 5 mol % of epoxy rings and about 15 to about 20 mol % of vinyl group-introduced monomers, and a heat curing agent hydroxyl value:binder hydroxyl value equivalent weight ratio may be about 0.5:1 to about 1:1.

At least one of the above and other features and advantages may also be realized by providing a method of packaging a device, the method including providing a die and a next-level substrate, and bonding the die with the next-level substrate using an adhesive film, such that the adhesive film is disposed between the die and the next-level substrate. The adhesive film may include an elastomer resin, an epoxy resin, a phenolic curing resin, and a silsesquioxane oligomer, the silsesquioxane oligomer being present in an amount of about 0.01 to about 3 wt. %, based on the total solids content of the composition.

At least one of the above and other features and advantages may also be realized by providing a device package, including a die, an adhesive film, and a next-level substrate. The die may be bonded to the next-level substrate by the adhesive film, and the adhesive film may include an elastomer resin, an epoxy resin, a phenolic curing resin, and a silsesquioxane oligomer, the silsesquioxane oligomer being present in an amount of about 0.01 to about 3 wt. %, based on the total solids content of the composition.

The next-level substrate may be a metal lead frame, and the metal lead frame may be substantially copper or substantially alloy 42.

### BRIEF DESCRIPTION OF THE DRAWINGS

The above and other features and advantages will become more apparent to those of ordinary skill in the art by describing in detail exemplary embodiments with reference to the attached drawings, in which:

FIGS. 1A and 1B illustrate Formulae 1 through 4;

FIG. 2 illustrates Table 1 listing components of Examples 1 to 4;

FIG. 3 illustrates Table 2 listing components of Comparative Examples 1 to 3;

FIG. 4 illustrates Table 3 listing physical properties of films obtained from Examples 1 to 4; and

FIG. 5 illustrates Table 4 listing physical properties of films obtained from Comparative Examples 1 to 3; and

FIG. 6 illustrates a device package including a die bonded to a next-level substrate using an adhesive film according to an embodiment.

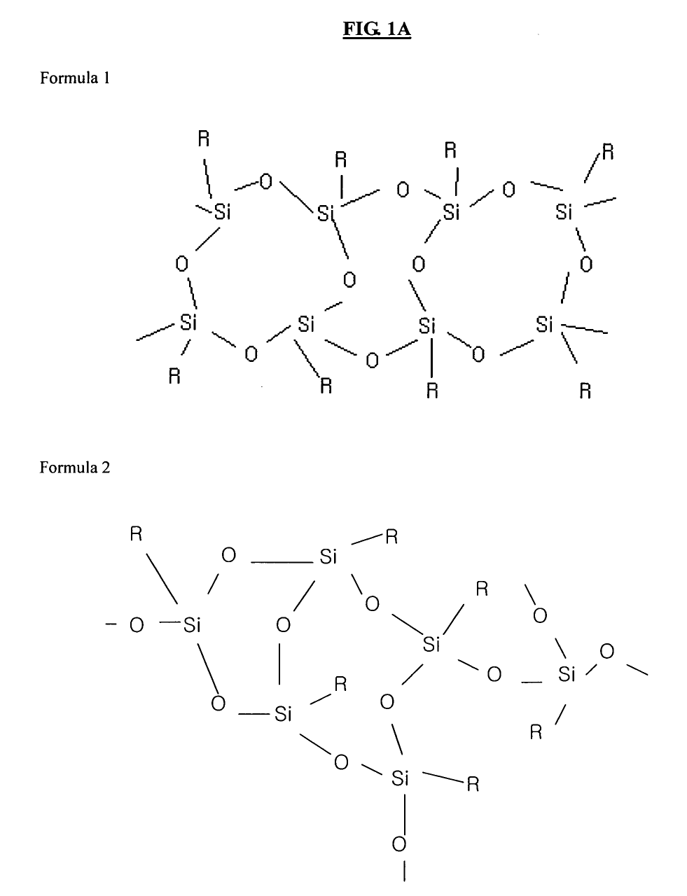

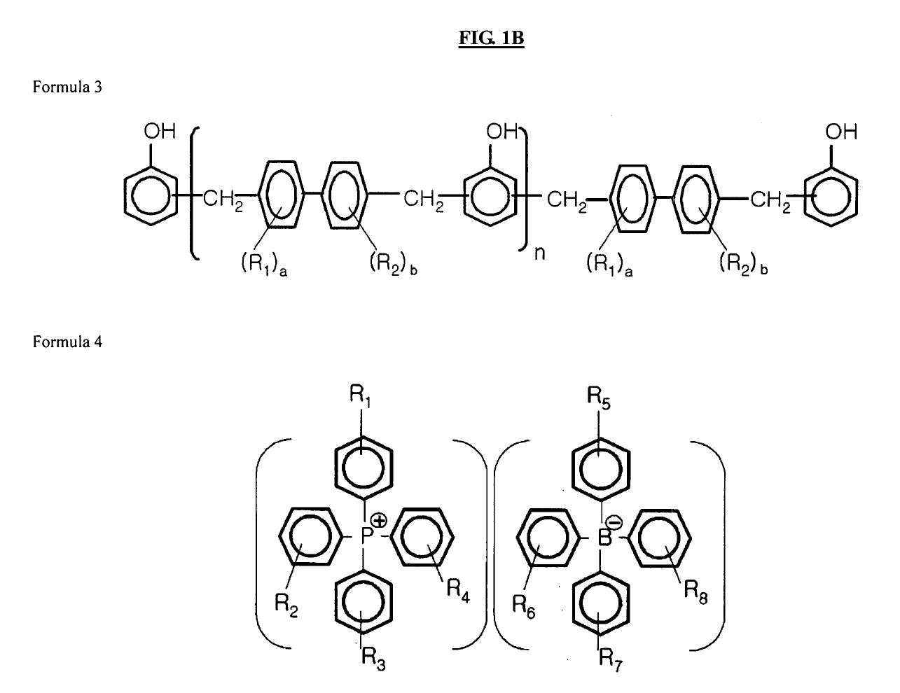

### DETAILED DESCRIPTION

Korean Patent Application No. 10-2007-0134390, filed on Dec. 20, 2007, in the Korean Intellectual Property Office, and entitled: “Adhesive Film Composition for Semiconductor Assembly and Adhesive Film Therefrom,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a silane coupling agent” may represent a single compound, e.g., 3-glycidoxytrimethoxysilane, or multiple compounds in combination, e.g., 3-glycidoxytrimethoxysilane mixed with 3-glycidoxypropyltriethoxysilane.

As used herein, molecular weights of polymeric materials are weight average molecular weights, unless otherwise indicated.

As used herein, the terms “% by weight” and “wt. %” are interchangeable, and mean percentage by weight. Language such as “% by weight, based on the total solids content of the composition” means that the weight is determined exclusive of solvent, unless otherwise indicated. That is, as used herein, the point of reference “the total amount of the adhesive film composition” does not include solvent. For example, where a composition is composed of two components A and B, with A present in 35% by weight and B present in 65% by weight, based on the total solids content of the adhesive film composition, the addition of solvent to the composition would result in the composition continuing to have 35% by weight A and 65% by weight B, based on the total solids content of the adhesive film composition.

An adhesive film composition according to an embodiment may be used for semiconductor assembly. The composition may include an elastomer resin, an epoxy resin, a phenolic curing resin, and a silsesquioxane oligomer. The silsesquioxane oligomer may provide a high level of adhesion to a next-level substrate such as a lead frame made of a metal, e.g., copper or Alloy 42. Therefore, the composition may provide high adhesive strength even after moisture absorption, and may ensure reflow resistance to provide a highly reliable adhesive film suitable for semiconductor assembly.

In an embodiment, the amount of the silsesquioxane oligomer in the composition may be about 0.01 to about 3% by weight, based on the total solids content of the composition. The silsesquioxane oligomer may have a chemical formula RSiO_{3/2}, in which R may be independently a hydrogen atom, an alkyl group, an alkene group, an aryl group, or an arylene group. The silsesquioxane may have a ladder structure, e.g., as represented by Formula 1 below, or a random structure, e.g., as respresented by Formula 2 below. A weight-average molar mass of the silsesquioxane oligomer may be 5000 and less, and preferably 2000 and less.

The silsesquioxane oligomer may be represented by Formula 1 or Formula 2:

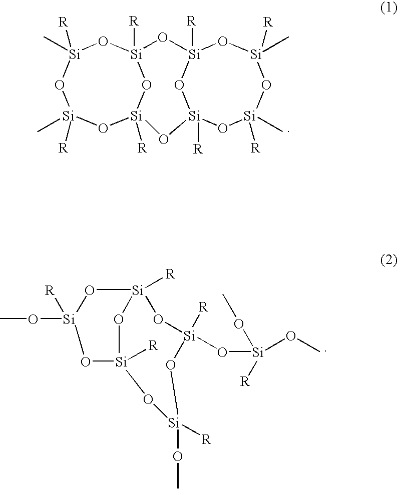

In Formulae 1 and 2, each R may independently be an hydrogen atom, an alkyl group, an alkene group, an aryl group, or an arylene group. In an implementation, each R may be the same, e.g., all methyl, all hydrogen, etc.

The adhesive film composition having the silsesquioxane oligomer may provide high adhesive strength, even after moisture absorption, and may ensure reflow resistance to provide a highly reliable adhesive film suitable for semiconductor assembly. Generally, dies may be attached to a printed circuit board or a moisture-sensitive metal lead frame. When an adhesive film according to an embodiment is applied to a metal lead frame, high adhesive strength may be imparted by hydrogen bonding between the alkyl groups of Formulae 1 and 2 and the metal lead frame, even during moisture absorption, to provide reflow resistance and high reliability in PCT testing and other tests.

It is preferable to use the silsesquioxane oligomer in an amount of about 0.01 to about 3% by weight, more preferably about 0.05 to about 3% by weight, and most preferably about 0.05 to about 1.0% by weight, based on the total solids content of the adhesive film composition. The use of the silsesquioxane oligomer in an amount of about 3% by weight or less may avoid reductions in adhesion to a silicon die and reductions in the coating strength of the adhesive film, which may decrease the adhesive strength of the adhesive film.

The elastomer resin included in the adhesive film composition is a rubber component that imparts strength to the adhesive film, making the film easy to handle and allowing for the formation of an adhesive film with proper adhesive strength. The elastomer resin preferably contains a hydroxyl, carboxyl, or epoxy group.

The weight average molecular weight of the elastomer resin is preferably about 50,000 to about 5,000,000, and more preferably about 100,000 to about 800,000. Examples of elastomer resins suitable for use in exemplary embodiments include acrylonitrile-based elastomers, butadiene-based elastomers, styrene-based elastomers, acrylate-based elastomers, isoprene-based elastomers, ethylene-based elastomers, propylene-based elastomers, polyurethane-based elastomers, and silicone-based elastomers.

The amount of the elastomer resin in the adhesive film composition may be about 5 to about 75% by weight, preferably about 20 to about 70% by weight, more preferably about 40 to about 60% by weight, and most preferably about 50 to about 60% by weight, based on the total solids content of the adhesive film composition.

The epoxy resin included in the adhesive film composition may serve as a curable adhesive. The epoxy resin may be in a solid or liquid state that provides curability and adhesiveness. Preferably, the epoxy resin has at least one functional group.

The epoxy resin preferably has an epoxy equivalent weight of about 100 to about 1,500 g/eq., more preferably about 150 to about 800 g/eq., and most preferably about 150 to about 400 g/eq. A cured product of the epoxy resin having an epoxy equivalent weight of about 100 g/eq. or more may provide advantageous levels of adhesiveness. An epoxy resin having an epoxy equivalent weight of about 1,500 g/eq. or less may be advantageous because of a high glass transition temperature and good heat resistance.

The epoxy resin may include, e.g., a bisphenol-type epoxy resin, an ortho-cresol novolac-type epoxy resin, a multifunctional epoxy resin, an amine-type epoxy resin, a heterocyclic epoxy resin, a substituted epoxy resin, or a naphthol-type epoxy resin.

Examples of commercially available bisphenol-type epoxy resins include Epiclon 830-S, Epiclon EXA-830CRP, Epiclon EXA 850-S, Epiclon EXA-850CRP and Epiclon EXA-835LV (Dainippon Ink and Chemicals Inc., Japan); Epicoat 807, Epicoat 815, Epicoat 825, Epicoat 827, Epicoat 828, Epicoat 834, Epicoat 1001, Epicoat 1004, Epicoat 1007 and Epicoat 1009 (Yuka-Shell Epoxy Co., Ltd. (Japan)); DER-330, DER-301, and DER-361 (Dow Chemical); and Yd-128 and YDF-170 (Kukdo Chemical Co., Ltd. (Korea)).

Examples of commercially available ortho-cresol novolac type epoxy resins include YDCN-500-1P, YDCN-500-4P, YDCN-500-5P, YDCN-500-7P, YDCN-500-80P and YDCN-500-90P (Kukdo Chemical Co., Ltd. (Korea)); and EOCN-102S, EOCN-103S, EOCN-104S, EOCN-1012, EOCN-1025 and EOCN-1027 (Nippon Kayaku Co., Ltd. (Japan)).

Examples of commercially available multifunctional epoxy resins include Epon 1031 S (Yuka-Shell Epoxy Co., Ltd. (Japan)); Araldite 0163 (CIBA Specialty Chemicals); and Denacol EX-611, Denacol EX-614, Denacol EX-614B, Denacol EX-622, Denacol EX-512, Denacol EX-521, Denacol EX-421, Denacol EX-411 and Denacol EX-321 (Nagase ChemteX Corp., Japan).

Examples of commercially available amine type epoxy resins include Epicoat 604 (Yuka-Shell Epoxy Co., Ltd. (Japan)); YH-434 (Tohto Kasei Co., Ltd. (Japan)); TETRAD-X and TETRAD-C (Mitsubishi Gas Chemical Company Inc., Japan); and ELM-120 (Sumitomo Chemical Co., Ltd. (Japan)).

The heterocyclic epoxy resin is commercially available under the trademark PT-810 from CIBA Specialty Chemicals.

Examples of commercially available substituted epoxy resins include ERL-4234, ERL-4299, ERL-4221 and ERL-4206 (UCC).

Examples of commercially available naphthol type epoxy resins include Epiclon HP-4032, Epiclon HP-4032D, Epiclon HP-4700 and Epiclon 4701 (Dainippon Ink and Chemicals, Inc., Japan).

The epoxy resins may be used alone, or as a mixture of two or more thereof.

The amount of epoxy resin in the adhesive film composition may be about 3 to about 40% by weight, preferably about 5 to about 30% by weight, more preferably about 7 to about 21% by weight, and most preferably about 10 to about 16% by weight, based on the total solids content of the adhesive film composition.

The phenolic curing resin included in the adhesive film composition is preferably a compound having two or more phenolic hydroxyl groups in one molecule. Preferable phenolic curing resins include bisphenol curing resins such as bisphenol A, bisphenol F and bisphenol S resins, as well as phenolic resins such as phenol novolac resins, bisphenol A novolac resins, cresol novolac resins, xylok resins, and biphenyl resins, all of which exhibit excellent electrolytic corrosion resistance when exposed to moisture.

Examples of commercially available phenolic curing resins include: simple phenolic curing resins, such as H-1, H-4, HF-1M, HF-3M, HF-4M and HF-45 (Meiwa Plastic Industries, Ltd., Japan); para-xylene type curing resins, such as MEH-78004S, MEH-7800SS, MEH-7800S, MEH-7800M, MEH-7800H, MEH-7800HH and MEH-78003H (Meiwa Plastic Industries, Ltd., Japan); KPH-F3065 (Kolon Chemical Co., Ltd. (Korea)); biphenyl type curing resins, such as MEH-7851SS, MEH-7851S, MEH7851M, MEH-7851H, MEH-78513H and MEH-78514H (Meiwa Plastic Industries, Ltd. (Japan)) and KPH-F4500 (Kolon Chemical Co., Ltd. (Korea)); and triphenylmethyl type curing resins, such as MEH-7500, MEH-75003S, MEH-7500SS, MEH-7500S and MEH-7500H (Meiwa Plastic Industries, Ltd. (Japan)).

The phenolic curing agents may be used alone, or as a mixture of two or more thereof.

The phenolic curing resin is preferably represented by Formula 3:

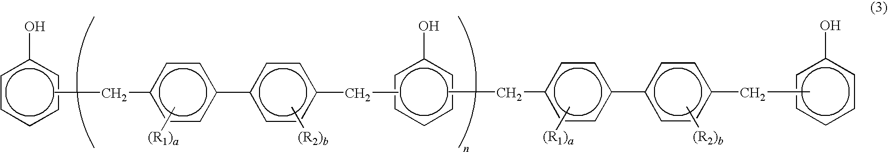

In Formula 3, R₁ and R₂ may each independently be a C₁-C₄ alkyl group or a hydrogen atom, a and b may each independently be an integer from 0 to 4, and n may be an integer from 0 to 7.

The phenolic curing resin of Formula 3 has two or more hydroxyl groups in its molecular structure, exhibits excellent electrolytic corrosion resistance when exposed to moisture, and exhibits good heat resistance and superior reflow resistance because of its low moisture adsorption.

The phenolic curing resin of Formula 3 preferably has a hydroxyl equivalent weight of about 100 to about 600 g/eq., and more preferably about 170 to about 300 g/eq. If the hydroxyl equivalent weight of the phenolic curing resin is about 100 g/eq. or more, moisture absorption may be reduced and reflow resistance may be improved. If the hydroxyl equivalent weight of the phenolic curing resin is about 600 g/eq. or less, the glass transition temperature may be increased and the heat resistance may be enhanced.

It is preferable that the ratio of the epoxy equivalent weight of the epoxy resin to the hydroxyl equivalent weight of the phenolic curing resin is about 0.6:1 to about 1.6:1 (epoxy equivalent weight of the epoxy resin:hydroxyl equivalent weight of the phenolic curing resin), and more preferably about 0.8:1 to about 1.2:1. Maintaining the mixing ratio at about 0.6:1 to about 1.6:1 may help ensure good adhesiveness and curability of the adhesive film.

The adhesive film composition may further include one or more of a silane coupling agent, a curing accelerator, and a filler.

The silane coupling agent included in the adhesive film composition may function as an adhesion enhancer for enhancing the adhesion of the resins to the surface of inorganic materials (e.g., silica filler) in the composition. Thus, the use of the silane coupling agent may contribute to further improvement in the adhesive strength of the adhesive film composition. The silane coupling agent may include, e.g., an epoxy-containing silane, an amine-containing silane, or a mercapto-containing silane.

Exemplary silane compounds include: epoxy-containing silanes such as 2-(3,4-epoxycyclohexyl)-ethyltrimethoxysilane, 3-glycidoxytrimethoxysilane, and 3-glycidoxypropyltriethoxysilane; amine-containing silanes such as N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, and N-phenyl-3-aminopropyltrimethoxysilane; and mercapto-containing silanes such as 3-mercaptopropylmethyldimethoxysilane and 3-mercaptopropyltriethoxysilane; and isocyanate-containing silanes, such as 3-isocyanatopropyltriethoxysilane.

The silane compounds may be used alone, or in combination of two or more thereof.

The amount of the silane coupling agent in the adhesive film composition is preferably about 0.01 to about 10% by weight, more preferably about 0.3 to about 5% by weight, and most preferably about 0.5 to about 3% by weight, based on the total solids content of the adhesive film composition.

The curing accelerator included in the adhesive film composition may function as a catalyst for shortening the curing time, so as to completely cure the epoxy resin during the course of semiconductor assembly. Example curing accelerators include phosphine-type curing accelerators, boron-type curing accelerators, and imidazole-type curing accelerators.

Example phosphine-type curing accelerators include triphenylphosphine, tri-o-tolylphosphine), tri-m-tolylphosphine, tri-p-tolylphosphine, tri-2,4-xylylphosphine, tri-2,5-xylylphosphine, tri-3,5-xylylphosphine, tribenzylphosphine, tris(p-methoxyphenyl)phosphine, tris(p-tert-butoxyphenyl)phosphine, diphenylcyclohexylphosphine, tricyclohexylphosphine, tributylphosphine, tri-tert-butylphosphine, tri-n-octylphosphine, diphenylphosphinostyrene, diphenylphosphinous chloride, tri-n-octylphosphine oxide, diphenylphosphinyl hydroquinone, tetrabutylphosphonium hydroxide, tetrabutylphosphonium acetate, benzyltriphenylphosphonium hexafluoroantimonate, tetraphenylphosphonium tetraphenylborate, tetraphenylphosphonium tetra-p-tolylborate, benzyltriphenylphosphonium tetraphenylborate, tetraphenylphosphonium tetrafluoroborate, p-tolyltriphenylphosphonium tetra-p-tolylborate, triphenylphosphine triphenylborane, 1,2-bis(diphenylphosphino)ethane, 1,3-bis(diphenylphosphino)propane, 1,4-bis(diphenylphosphino)butane, and 1,5-bis(diphenylphosphino)pentane.

Example boron-type curing accelerators include phenylboronic acid, 4-methylphenylboronic acid, 4-methoxyphenylboronic acid, 4-trifluoromethoxyphenylboronic acid, 4-tert-butoxyphenylboronic acid, 3-fluoro-4-methoxyphenylboronic acid, pyridine-triphenylborane, 2-ethyl-4-methylimidazolium tetraphenylborate, 1,8-diazabicyclo[5.4.0]undecene-7-tetraphenylborate, 1,5-diazabicyclo[4.3.0]nonene-5-tetraphenylborate, and lithium triphenyl(n-butyl)borate.

Example imidazole type curing accelerators include 2-methylimidazole, 2-undecylimidazole, 2-heptadecylimidazole, 2-ethyl-4-methylimidazole, 2-phenylimidazole, 2-phenyl-4-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecylimidazolium trimellitate, 1-cyanoethyl-2-phenylimidazolium trimellitate, 2,4-diamino-6-[2′-methylimidazoly-(1′)]-ethyl-s-triazine, 2,4-diamino-6-[2′-undecylimidazoly-(1′)]-ethyl-s-triazine, 2,4-diamino-6-[2′-ethyl-4′-methylimidazoly-(1′)]-ethyl-s-triazine, 2,4-diamino-6-[2′-methylimidazoly-(1′)]-ethyl-s-triazine isocyanuric acid adduct dihydrate, 2-phenylimidazole isocyanuric acid adduct, 2-methylimidazole isocyanuric acid adduct dihydrate, 2-phenyl-4,5-dihydroxymethylimidazole, 2-phenyl-4-methyl-5-hydroxymethylimidazole, 2,3-dihydro-1H-pyrrolo[1,2-a]benzimidazole, 4,4′-methylene-bis(2-ethyl-5-methylimidazole), 2-methylimidazoline, 2-phenylimidazoline, 2,4-diamino-6-vinyl-1,3,5-triazine, 2,4-diamino-6-vinyl-1,3,5-triazine isocyanuric acid adduct, 2,4-diamino-6-methacryloyloxylethyl-1,3,5-triazine isocyanuric acid adduct, 1-(2-cyanoethyl)-2-ethyl-4-methylimidazole, 1-cyanoethyl-2-methylimidazole, 1-(2-cyanoethyl)-2-phenyl-4,5-di-(cyanoethoxymethyl)imidazole, 1-acetyl-2-phenylhydrazine, 2-ethyl-4-methylimidazoline, 2-benzyl-4-methyl diimidazoline, 2-ethylimidazoline, 2-phenyl-4,5-dihydroxymethylimidazole, melamine, and dicyandiamide.

The curing accelerators may be used alone, or in combination of two or more thereof.

In an embodiment, the curing accelerator may be a compound represented by Formula 4:

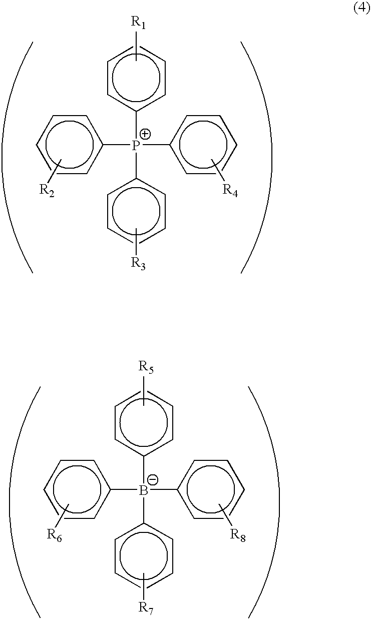

In Formula 4, R₁ through R₈ may each independently be a hydrogen atom, a halogen atom, or an alkyl group.

The curing accelerator represented by Formula 4 may have a higher initiating temperature for a curing reaction than that of an amine curing agent or an imidazole curing catalyst, may be useful for attaining a uniform curing rate, and may show a relatively low reactivity at room temperature, thus providing excellent storage stability. Thus, in a preferred embodiment, a curing accelerator represented by Formula 4 may be used to inhibit a curing reaction from progressing at room temperature, so that failures during semiconductor assembly caused by irregular curing properties may be reduced. Furthermore, the adhesive composition including the curing accelerator represented by Formula 4 may exhibit a relatively low electrical conductivity compared to an adhesive composition containing an amine curing catalyst or an imidazole curing catalyst, resulting in excellent reliability during a “Pressure Cooker Test (PCT).”

The amount of the curing accelerator in the adhesive film composition is preferably about 0.01 to about 10% by weight, and more preferably about 0.03 to about 5% by weight, based on the total solids content of the adhesive film composition. The presence of the curing accelerator in an amount of about 0.01% by weight or more may help ensure sufficient crosslinking of the epoxy resin and may enhance heat resistance. Maintaining the amount of the curing catalyst at about 10 wt. % or less may help ensure that the storage stability of the composition is not deteriorated.

The filler included in the adhesive film composition may help impart thixotropic properties to the composition to control the melt viscosity of the composition. An inorganic or organic filler may be used. As the inorganic filler, there can be used a metal component, e.g., gold, silver, copper, or nickel powder, or a non-metallic component, e.g., alumina, aluminum hydroxide, magnesium hydroxide, calcium carbonate, magnesium carbonate, calcium silicate, magnesium silicate, calcium oxide, magnesium oxide, aluminum nitride, silica, boron nitride, titanium dioxide, glass, iron oxide, ceramic, etc. The organic filler may be a carbon-based filler, rubber-based filler, polymer-based filler, etc.

Spherical silica or amorphous silica may be used as the inorganic filler. The average particle diameter of the filler is preferably about 5 nm to about 10 μm, and more preferably about 10 nm to about 3 μm.

The filler is preferably used in an amount of about 3 to about 60% by weight, and more preferably about 5 to about 30% by weight, based on the total solids content of the adhesive film composition. If the filler is used in an amount of about 3% by weight or more, filler may provide good reinforcing effects. If the filler is used in an amount of about 60% by weight or less, reductions in adhesion to an adherend may be reduced.

The adhesive film composition may further include an organic solvent to provide low viscosity, thus facilitating film formation. Taking into consideration the volatility of the organic solvent during film formation, the organic solvent may be, e.g., toluene, xylene, propylene glycol monomethyl ether acetate, benzene, acetone, methyl ethyl ketone, tetrahydrofuran (THF), dimethylformamide (DMF), cyclohexanone, or mixtures thereof.

The organic solvent may be present in an amount of 5 to 85% by weight with respect to the total weight of the adhesive film composition. In an implementation, the residual content of the organic solvent remaining after film formation may be about 1 wt. % or less. Volatile organic solvent remaining in an excessive amount may induce the formation of voids when dies are attached to a next-level substrate, e.g., a printed circuit board (PCB), in the semiconductor assembly processes.

Another embodiment provides a dicing die bonding film formed using an adhesive film according to an embodiment. The dicing die bonding film may be produced by coating a UV-curable adhesive layer or a general curable pressure-sensitive adhesive on a base film of, e.g., vinyl chloride or polyolefin film. An adhesive film according to an embodiment may be provided on the UV-curable adhesive layer or pressure-sensitive adhesive. Thus, the dicing die bonding film may be a laminate of an adhesive film according to an embodiment and a dicing film, i.e., the dicing die bonding film may be produced by sequentially laminating a pressure-sensitive adhesive layer and an adhesive film according to an embodiment on a base film.

A semiconductor wafer may be attached to the dicing die bonding film, followed by cutting the wafer into pieces by dicing. The die adhesive film, i.e., the adhesive film according to an embodiment, should be released simultaneously with the die during the pick-up process. Further, voids such as air bubbles should be minimized during adhesion of the adhesive film to the back surface of the semiconductor wafer. Reflowing may be carried out to mount a semiconductor package on a substrate. Thus, the adhesive film layer should have good reflow resistance and temperature cycle resistance, such that the adhesive film attached to chips within the semiconductor package does not peel or allow the chips to crack.

A general apparatus or equipment may be used to form an adhesive film for semiconductor assembly from the adhesive film composition according to an embodiment. The film may be formed by a generally known method. For example, the phenolic curing resin, the silsesquioxane oligomer, the silane coupling agent, the curing accelerator, the filler, etc., may be dissolved in the organic solvent. Then, the resulting solution may be kneaded using a bead mill, applied to a release-treated polyethylene terephthalate (PET) film, and heat-dried to form an adhesive film with an appropriate coating thickness. The thickness of the adhesive film is preferably adjusted to about 5 to about 200 μm, and more preferably about 10 to about 100 μm. A thickness of about 5 μm or more may help ensure sufficient adhesive strength. A thickness of about 200 μm or less may avoid waste.

It is preferred that the base film is radiation-transmissive. The base film may be formed of a highly light-transmissive material when a radiation curable pressure-sensitive adhesive responding to UV irradiation is applied to the base film. Examples of polymeric materials for the base film include polyolefin homopolymers and copolymers, such as polyethylene, polypropylene, propylene-ethylene copolymers, ethylene-ethyl acrylate copolymers, ethylene-methyl acrylate copolymers, and ethylene-vinyl acetate copolymers, as well as polycarbonate, polymethyl methacrylate, polyvinyl chloride, and polyurethane copolymers. The thickness of the base film may be determined taking into consideration factors such as tensile strength, elongation, and radiation transmission, and is preferably about 50 to about 200 μm.

The pressure-sensitive adhesive layer may be formed of a general pressure-sensitive adhesive composition. For example, the pressure-sensitive adhesive layer may contain an acrylic pressure-sensitive adhesive binder having vinyl groups and a heat curing agent. The binder may have a hydroxyl value of about 15 to about 30 and an acid value of 1 or less. The binder may contain about 2 to about 5 mol % of epoxy rings and about 15 to about 20 mol % of vinyl group-introduced monomers, and the equivalent weight ratio of the hydroxyl value of the heat curing agent to the hydroxyl value of the binder may be about 0.5:1 to about 1:1.

About 80% or more of the pressure-sensitive adhesive composition may be cured at a UV dose of 100 to 450 mJ/cm². Further, the pressure-sensitive adhesive composition may have a peel strength of 0.05 N/25 mm or more, as measured at different rates of 6, 50, 300, and 1,000 mm/min after photocuring.

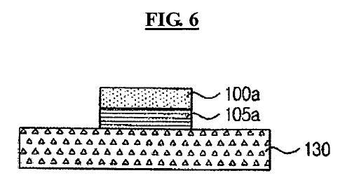

FIG. 6 illustrates a device package including a die, an adhesive film layer, and a next-level substrate according to an embodiment. Referring to FIG. 6, an adhesive film layer 105a according to an embodiment may be disposed between a die 100a and a next level substrate 130. The die may be, e.g., a semiconductor die, an optical or electro-optical die, a microelectromechanical system (MEMS) die, etc. The next-level substrate may be, e.g., another die, a printed circuit board, a lead frame, an interposer, etc. The next-level substrate may contain a metal. In an implementation, the next-level substrate may be a lead frame formed from copper, Alloy 42 (nominal composition 58% Fe (iron) and 42% Ni (nickel)), etc. The lead frame may be substantially copper, i.e., 50 wt. % or more copper, substantially Alloy 42, etc. The die 100a and the adhesive film layer 105a may be encapsulated, e.g., with an epoxy molding compound, etc., on the next-level substrate 130.

The following Examples and Comparative Examples are provided in order to set forth particular details of one or more embodiments. However, it will be understood that the embodiments are not limited to the particular details described.

### EXAMPLES

### Examples 1-4 and Comparative Examples 1-3

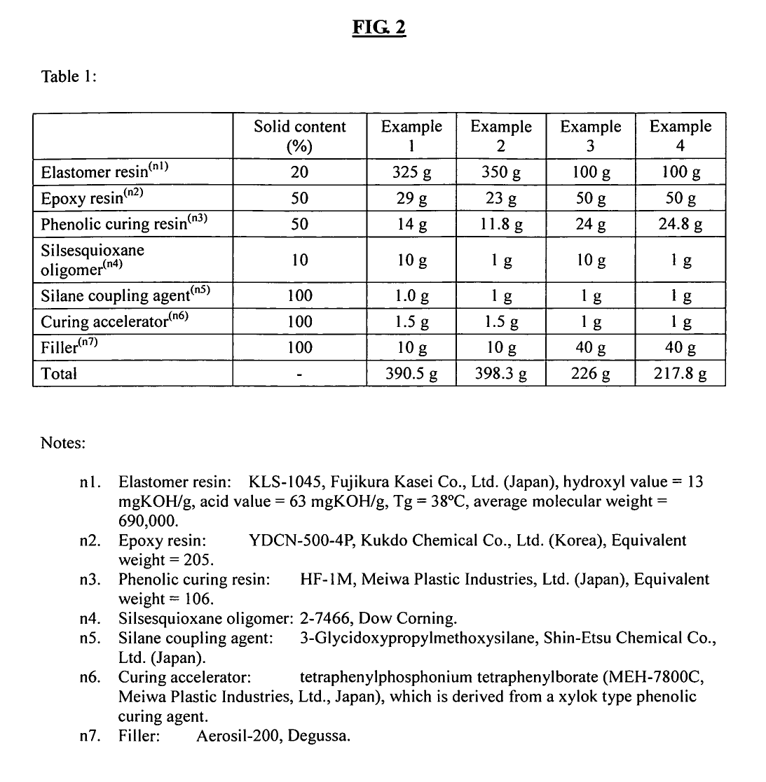

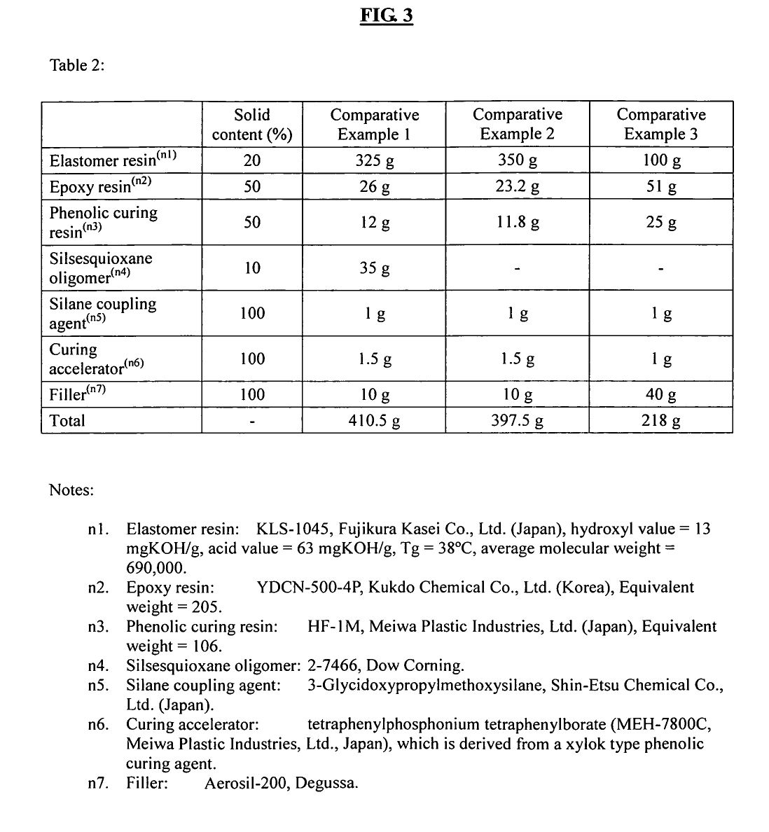

The components shown in FIG. 2, Table 1 for Examples 1-4 and FIG. 3, Table 2 for Comparative Examples 1-3 were put into a 1 L cylindrical flask equipped with a high-speed agitator and dispersed at 4,000 rpm for 20 minutes to prepare respective adhesive film compositions. Each of the adhesive film compositions was finely ground using a bead mill for 30 minutes. The grinding was repeated a total of two times or more. The resultant powder was filtered through a 50 μm capsule filter, coated to a thickness of 20 μm on a release-treated polyethylene terephthalate (PET) film using an applicator, and dried at 90-120° C. for 20 minutes to obtain an adhesive film. The elastomer resin was dissolved in toluene until the solid content reached 20 parts by weight, each of the epoxy resin and the phenolic curing resin was dissolved in methyl ethyl ketone (MEK) to prepare a solution having a solid content of 50 parts by weight, and the silsesquioxane oligomer was dissolved in cyclohexanone to prepare a solution having a solid content of 10 parts by weight.

Evaluation of Physical Properties of the Adhesive Films

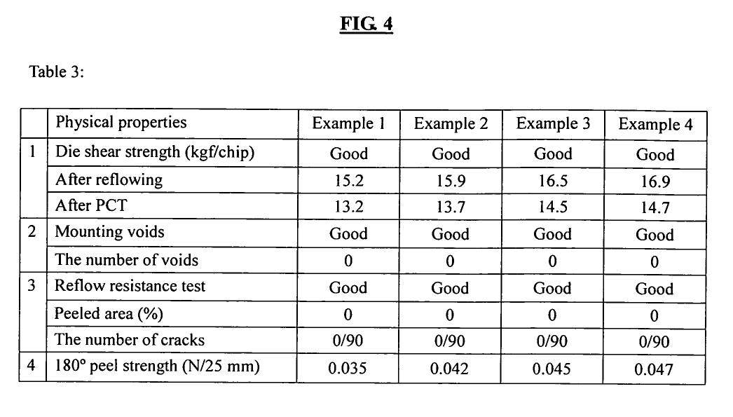

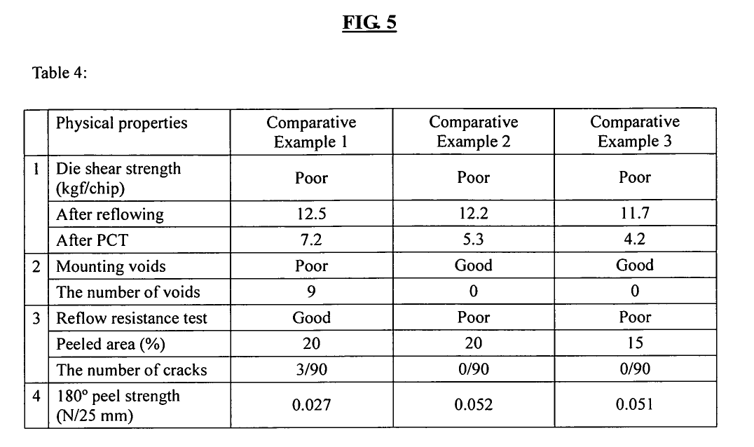

The adhesive films produced in Examples 1-4 and Comparative Examples 1-3 were evaluated for physical properties as follows, and the results are shown in FIGS. 4 and 5, Tables 3 and 4, respectively. After reflow resistance and temperature cycle resistance tests were conducted on the adhesive films, peeling and cracks of the adhesive films were observed by scanning acoustic tomography (SAT). The adhesive films were measured for die shear strength and the results are presented in Tables 3 and 4.

(1) Die Shear Strength:

A 530 μm-thick wafer coated with an oxide film was cut into chips having a size of 5 mm×5 mm. The chips were laminated with the respective adhesive films at 60° C. Each of the laminates was cut to leave the adhered portion thereof only. The chip (5 mm×5 mm) was placed on an Alloy 42 lead frame (10 mm×10 mm), pressed under a load of 1 kgf on a hot plate at 120° C. for one second to attach the chip to the lead frame, and then cured at 175° C. for 2 hours. The resultant test piece was allowed to absorb moisture at 85° C./85% RH for 168 hours, and reflowing was conducted three times at a maximum of 260° C. Thereafter, the die shear strength of the test piece was measured. After a pressure-cooker test (PCT) for 168 hours, the die shear strength was again measured at 250° C. The results are shown in Tables 3 and 4.

(2) Mounting voids: A 530 μm-thick wafer (diameter 100 mm) coated with an oxide film was laminated with each of the adhesive films at 60° C. An observation was made as to whether mounting voids larger than 1 mm in size were formed. The laminates were judged to be ‘good’ when the number of the mounting voids was zero, ‘fair’ when the number of the mounting voids was three or less, and ‘poor’ when the number of the mounting voids was four or more.

(3) Reflow resistance test: Each of the adhesive films was mounted on a 100 μm-thick wafer coated with an oxide film, and cut into chips having a size of 8 mm×8 mm and a size of 10 mm×10 mm. The chips of different sizes were attached on a QDP package to form a two-layer structure. The resulting structure was molded with an epoxy molding compound (EMC) (SG-8500BC, Cheil Industries, Korea) at 175° C. for 60 seconds, and post-cured at 175° C. for 2 hours to obtain test pieces. The test pieces were allowed to absorb moisture at 85° C./85% RH for 168 hours, and reflowing was conducted three times at a maximum of 260° C. Thereafter, peeling and cracks of the test pieces were observed by scanning acoustic tomography (SAT). The results are shown in Tables 3 and 4. The test pieces were judged to be ‘poor’ when 10% or more of the test piece was peeled and cracks were observed.

(4) 180° peel strength: Each of the adhesive films was laminated with a dicing film composed of a pressure-sensitive adhesive layer and a polyolefin film at room temperature (25° C.), left to stand for one hour, and then cut into a rectangular film having a size of 25 mm (w)×70 mm (l). The 180° peel strength of the rectangular film was measured using a universal testing machine (Instron). The 180° peel strength was measured at a peel rate of 300 mm/min. The dicing film (Cheil Industries, Korea) was produced by coating a UV-curable pressure-sensitive adhesive (10 μm) on a polyolefin film (100 μm). The results are shown in Tables 3 and 4.

The results listed in Tables 3 and 4 show that the adhesive films according to embodiments (Examples 1-4 including the silsesquioxane oligomer) had higher die shear strength values after reflowing than the adhesive films of Comparative Example 1, which included a large amount of the silsesquioxane oligomer, and the adhesive films of Comparative Examples 2 and 3, which included no silsesquioxane oligomer. Particularly, the adhesive films of Examples 1-4 showed no significant decrease in die shear strength after PCT. In the adhesive film (Comparative Example 1) including a large amount of the silsesquioxane oligomer, voids occurred during mounting and, as a result, cracks were observed in the reflow test, indicating that high reliability was not obtained. Further, the adhesive films of Comparative Examples 2 and 3, which included no silsesquioxane oligomer, had low die shear strength values after PCT, indicating that high reliability in PCT was not obtained.

As apparent from the foregoing, the adhesive film composition including the silsesquioxane oligomer may provide high adhesive strength to a lead frame. In addition, an adhesive film composition according to embodiment may make it possible to provide an adhesive film that exhibits high reliability in a reflow process, PCT, and TC test.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An adhesive film composition for semiconductor assembly, the adhesive film composition comprising:
an elastomer resin;
an epoxy resin;
a phenolic curing resin; and
a silsesquioxane oligomer, wherein:
the silsesquioxane oligomer is present in an amount of about 0.01 to about 3 wt. %, based on the total solids content of the composition.

2. The adhesive film composition as claimed in claim 1, wherein:
the silsesquioxane oligomer is represented by Formula 1 or Formula 2: 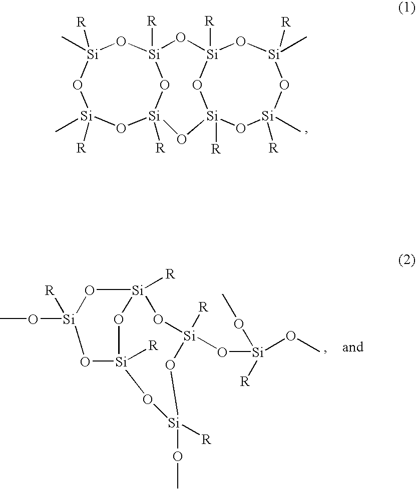
in Formulae 1 and 2, each R is independently a hydrogen atom, an alkyl group, an alkene group, an aryl group, or an arylene group.

3. The adhesive film composition as claimed in claim 1, wherein the elastomer resin contains a hydroxyl, carboxyl, or epoxy group.

4. The adhesive film composition as claimed in claim 1, wherein the epoxy resin includes one or more of a bisphenol-type epoxy resin, an ortho-cresol novolac-type epoxy resin, a multifunctional epoxy resin, an amine-type epoxy resin, a heterocyclic epoxy resin, a substituted epoxy resin, or a naphthol-type epoxy resin.

5. The adhesive film composition as claimed in claim 1, wherein:
the phenolic curing resin is represented by Formula 3: 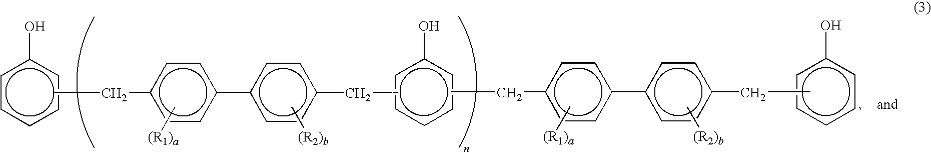
in Formula 3, R₁ and R₂ are each independently a C₁-C₄ alkyl group or a hydrogen atom, a and b are each independently integers from 0 to 4, and n is an integer from 0 to 7.

6. The adhesive film composition as claimed in claim 1, wherein the epoxy resin and the phenolic curing resin are present in an epoxy resin epoxy equivalent:phenolic curing resin hydroxyl equivalent weight ratio of about 0.6:1 to about 1.6:1.

7. The adhesive film composition as claimed in claim 1, further comprising a silane coupling agent, a curing accelerator, and a filler.

8. The adhesive film composition as claimed in claim 7, wherein:
the curing accelerator includes a compound represented by Formula 4: 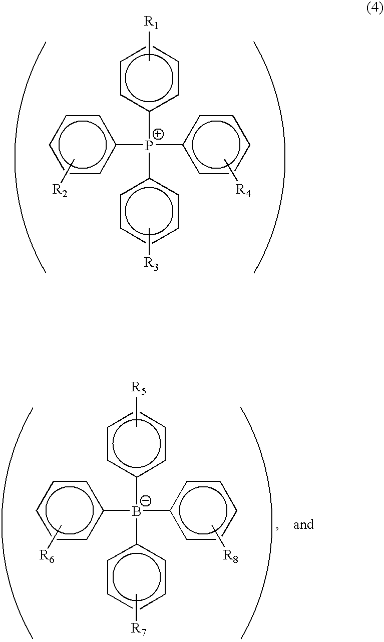
in Formula 4, R₁ through R₈ are each independently a hydrogen atom, a halogen atom, or an alkyl group.

9. The adhesive film composition as claimed in claim 7, wherein the filler is an inorganic filler having a spherical or amorphous shape and a size of about 5 nm to about 10 μm.

10. The adhesive film composition as claimed in claim 7, wherein the adhesive film composition includes:
about 5 to about 75 wt. % of the elastomer resin,
about 3 to about 40 wt. % of the epoxy resin,
about 3 to about 25 wt. % of the phenolic curing resin,
about 0.01 to about 10 wt. % of the silane coupling agent,
about 0.01 to about 10 wt. % of the curing accelerator, and
about 3 to about 60 wt. % of the filler.

11. The adhesive film composition as claimed in claim 1, wherein the adhesive film composition includes:
about 5 to about 75 wt. % of the elastomer resin,
about 3 to about 40 wt. % of the epoxy resin, and
about 3 to about 25 wt. % of the phenolic curing resin.

12. An adhesive film for semiconductor assembly, the adhesive film comprising:
an elastomer resin;
an epoxy resin;
a phenolic curing resin; and
a silsesquioxane oligomer, wherein:
the silsesquioxane oligomer is present in an amount of about 0.01 to about 3 wt. %, based on the total solids content of the composition.

13. A dicing die bonding film, comprising:
a base film;
a pressure-sensitive adhesive layer on the base film; and
an adhesive film on the pressure-sensitive adhesive layer, such that the pressure-sensitive adhesive layer is between the adhesive film and the base film, wherein the adhesive film includes:
an elastomer resin;
an epoxy resin;
a phenolic curing resin; and
a silsesquioxane oligomer, the silsesquioxane oligomer being present in an amount of about 0.01 to about 3 wt. %, based on the total solids content of the composition.

14. The dicing die bonding film as claimed in claim 13, wherein:
the pressure-sensitive adhesive layer includes an acrylic pressure-sensitive adhesive binder and a heat curing agent,
the binder has a hydroxyl value of about 15 to about 30 and an acid value of 1 or less,
the binder contains about 2 to about 5 mol % of epoxy rings and about 15 to about 20 mol % of vinyl group-introduced monomers, and
a heat curing agent hydroxyl value:binder hydroxyl value equivalent weight ratio is about 0.5:1 to about 1:1.

15. A method of packaging a device, the method comprising:
providing a die and a next-level substrate; and
bonding the die with the next-level substrate using an adhesive film, such that the adhesive film is disposed between the die and the next-level substrate, wherein the adhesive film includes:
an elastomer resin;
an epoxy resin;
a phenolic curing resin; and
a silsesquioxane oligomer, the silsesquioxane oligomer being present in an amount of about 0.01 to about 3 wt. %, based on the total solids content of the composition.

16. A device package, comprising:
a die;
an adhesive film; and
a next-level substrate, wherein:
the die is bonded to the next-level substrate by the adhesive film, and
the adhesive film includes:
an elastomer resin;
an epoxy resin;
a phenolic curing resin; and
a silsesquioxane oligomer, the silsesquioxane oligomer being present in an amount of about 0.01 to about 3 wt. %, based on the total solids content of the composition.

17. The device package as claimed in claim 16, wherein:
the next-level substrate is a metal lead frame, and
the metal lead frame is substantially copper or substantially alloy 42.
